(19) United States
(12) Patent Application Publication
(10) Pub. No.: US 2015/0349341 A1
(43) Pub. Date: Dec. 3, 2015

(54) NEGATIVE ELECTRODE MATERIAL, NEGATIVE ELECTRODE FOR LITHIUM ION SECONDARY BATTERY, LITHIUM ION SECONDARY BATTERY, AND MANUFACTURING METHOD THEREOF

(71) Applicant: Hitachi, Ltd., Tokyo (JP)

(72) Inventors: Kento HOSHI, Tokyo (JP); Akihide TANAKA, Tokyo (JP); Etsuko NISHIMURA, Tokyo (JP)

(73) Assignee: Hitachi, Ltd., Tokyo (JP)

(21) Appl. No.: 14/410,610

(22) PCT Filed: Jun. 12, 2013
(86) PCT No.: PCT/JP2013/066144

§ 371 Date: Dec. 23, 2014

(30) Foreign Application Priority Data
Jul. 2, 2012 (JP) 2012-148125

(51) Int. Cl. H01M 4/587; H01M 10/0525

(52) U.S. Cl. CPC H01M 4/587; H01M 10/0525; H01M 2004/027

(57) ABSTRACT

A reduction in irreversible capacity is attained without degrading other battery characteristics. A negative electrode material, a negative electrode for lithium ion secondary battery, a lithium ion secondary battery, and a manufacturing method thereof, the negative electrode material containing a carbonaceous material, in which the interplanar spacing (d₀₀₂) between (002) planes of the carbonaceous material determined by an X-ray wide-angle diffraction method is smaller than or equal to 0.338 nm, the integrated pore volume of the carbonaceous material in pore diameters of 2 nm or more to 3.5 nm or less determined from a gas adsorption method is 3.0×10⁻² cc/g or less, and, for example, a water-soluble polymer is contained in the carbonaceous material.

### TECHNICAL FIELD

The present invention relates to negative electrode materials, negative electrode for lithium ion secondary batteries, lithium ion secondary batteries, and manufacturing methods thereof.

### BACKGROUND ART

In recent years, development for lithium ion secondary batteries has been pursued actively. PTL 1 discloses a technique that can improve charging load characteristics by making the value of the ratio between the pore volume (V1) of pores of 4 nm to 10 nm in pore diameter and the pore volume (V2) of pores of 30 nm to 100 nm in pore diameter, V2/V1, 2.2 to 3.0. PTL 2 discloses a technique in which a non-aqueous electrolyte battery including a positive electrode, a negative electrode, and a non-aqueous electrolyte containing non-aqueous solvent and an electrolyte salt, the negative electrode including, as negative electrode active materials, first graphite with an integrated pore volume of 3×10⁻⁴ cm³/g or less in pore diameters of 10 Å or more to 1000 Å or less, and second graphite with an integrated pore volume of 6×10⁻⁴ cm³/g or more in pore diameters of 10 Å or more to 1000 Å or less, can prevent deterioration in cycle characteristics.

### CITATION LIST

### Patent Literature

PTL 1: JP 2003-272625 A

PTL 2: JP 2011-119139 A

### SUMMARY OF INVENTION

### Technical Problem

However, the technique described in PTL 1 can improve the charging load characteristics, but cannot reduce the irreversible capacity. The technique described in PTL 2 uses mesophase graphite with a small integrated pore volume, and thus can be expected to improve cycle characteristics, but cannot reduce the irreversible capacity, or rather, can lead to an increase in irreversible capacity.

One of the factors of high-temperature preservation deterioration of batteries is the decomposition of an electrolytic solution. Thus, a negative electrode material that causes a smaller initial amount of decomposition of an electrolytic solution (irreversible capacity), that is, negative electrode material that can hold reaction with an electrolytic solution lower improves high-temperature preservation characteristics more. The present invention has an object of providing a negative electrode material with a small irreversible capacity.

### Solution to Problem

An aspect of the present invention for solving the above problem is as described below.

A negative electrode material, a negative electrode for lithium ion secondary battery, a lithium ion secondary battery, and a manufacturing method thereof, the negative electrode material containing a carbonaceous material, in which the interplanar spacing (d₀₀₂) between (002)′ planes of the carbonaceous material determined by an X-ray wide-angle diffraction method is smaller than or equal to 0.338 nm, the integrated pore volume of the carbonaceous material in pore diameters of 2 nm or more to 3.5 nm or less determined from a gas adsorption method is 3.0×10⁻² cc/g or less, and, for example, a water-soluble polymer is contained in the carbonaceous material.

### Advantageous Effects of Invention

The present invention can attain a reduction in irreversible capacity without lowering other battery characteristics. Problems, configurations, and effects other than those described above will be made clear from the following description of embodiments.

### BRIEF DESCRIPTION OF DRAWINGS

FIG. 1 is a graph illustrating an example of a pore distribution map according to an embodiment of the present invention.

FIG. 2 is a schematic diagram of a lithium ion secondary battery used for measurement of charge-discharge characteristics in examples and in comparative examples.

FIG. 3 is a diagram schematically illustrating an internal configuration of a battery according to an embodiment of the present invention.

### DESCRIPTION OF EMBODIMENTS

Hereinafter, with reference to the drawings, an embodiment of the present invention will be described. Descriptions below illustrate specific examples of the details of the present invention, and the present invention is not limited to these descriptions. Various alternations and modifications by those skilled in the art are possible within the scope of the technical idea disclosed in the specification. In all the diagrams for illustrating the present invention, those having the same functions are denoted by the same reference signs, and redundant description of them will be omitted.

The word “step” in the specification includes not only an independent step but a step that cannot be clearly distinguished from some other step but can achieve an intended effect thereof.

A numerical range indicated using “to” in the specification indicates a range including numerical values described before and after “to” as a minimum value and a maximum value, respectively.

<Negative Electrode Material>

A negative electrode material in an embodiment of the present invention contains a material made of carbon. The carbonaceous material is not particularly limited as long as the value of the average interplanar spacing (d₀₀₂) thereof is 0.338 nm or less, and the integrated pore volume thereof in pore diameters of 2 to 3.5 nm is 3.0×10⁻² cc/g or less. The negative electrode material may be composed only of the carbonaceous material, or may contain a material in addition to the carbonaceous material.

<d₀₀₂>

The carbonaceous material is preferably 0.335 to 0.338 nm in value of the average interplanar spacing (d₀₀₂) obtained by measurement based on a JSPS method. Carbonaceous materials satisfying this include, for example, artificial graphite, natural graphite, or the like.

The average interplanar spacing (d₀₀₂) is preferably 0.335 to 0.338 nm in terms of battery capacity. When the average interplanar spacing is larger than 0.338 nm, crystallinity is lowered, and the capacity tends to decrease. On the other hand, the theoretical value of a graphite crystal is 0.335 nm, and thus it is preferable to be close to this value.

<Integrated Pore Volume>

The carbonaceous material in the embodiment of the present invention shows an excellent irreversible capacity reduction when the integrated pore volume in pore diameters of 2 to 3.5 nm is 3.0×10⁻² cc/g or less. In the range of 2 to 3.5 nm in pore diameter, decomposition of an electrolytic solution is likely to occur compared with other pores. Thus in order to achieve the effect of irreversible capacity reduction, it is preferable that the integrated pore volume in pore diameters of 2 to 3.5 nm be 3.0×10⁻² cc/g or less. The integrated pore volume in pore diameters of 2 to 3.5 nm of the carbonaceous material in the embodiment of the present invention is 3.0×10⁻² cc/g or less, preferably 2.5×10⁻² cc/g or less, and more preferably 1.5×10⁻² cc/g or less. When the integrated pore volume is greater than 3.0×10⁻² cc/g, the decomposition of an electrolytic solution or the like is likely to occur, increasing the irreversible capacity. In the present invention, the integrated pore volume can be determined by measuring the pore distribution on the adsorption side in a nitrogen adsorption measurement that can be calculated from the BJH method, using a gas adsorption apparatus (for example, AUTOSORB-1 manufactured by Quantachrome Instruments). In soft carbon and hard carbon, the percentage of presence of pores in pore diameters of 2 to 3.5 nm is small, while in graphite, pores in pore diameters of 2 to 3.5 nm correspond to an edge portion. Therefore, it is important to control the pore volume in pore diameters of 2 to 3.5 nm in a carbonaceous material with a value of average interplanar spacing (d₀₀₂) of 0.335 to 0.338 nm, such as graphite.

When the integrated pore volume in pore diameters of 2 to 3.5 nm of the carbonaceous material becomes 3.0×10⁻² cc/g or less, there is no particular limitation. The carbonaceous material may partly or entirely contain a carbonaceous material (low crystallinity carbon) different from the carbonaceous material, a metallic material, a polymer, or the like. They may be used as the carbonaceous material. Further, for a carbonaceous material, for example, one or more kinds of a low crystallinity carbon, a metallic material, a polymer, and the like may be used to make them the carbonaceous material, and prepared so that the integrated pore volume in pore diameters of 2 to 3.5 nm of the carbonaceous material is 3.0×10⁻² cc/g or less.

A metallic material used for preparing the carbonaceous material such that the integrated pore volume in pore diameters of 2 to 3.5 nm is 3.0×10⁻² cc/g or less is not particularly limited as long as it is a metal with low reactivity to L and may be Cu, Ni, stainless steel, or the like.

When low crystallinity carbon is used for preparing the carbonaceous material such that the integrated pore volume in pore diameters of 2 to 3.5 nm is 3.0×10⁻² cc/g or less, an increase in low crystallinity carbon can increase the irreversible capacity. Thus it is preferable to make determinations as appropriate so as not to lower the battery characteristics.

When low crystallinity carbon is used for preparing the carbonaceous material such that the integrated pore volume in pore diameters of 2 to 3.5 nm is 3.0×10⁻² cc/g or less, a method of obtaining low crystallinity carbon from a carbon precursor using a wet mixing method, a chemical vapor deposition method, a mechanochemical method, or the like may be included. A chemical vapor deposition method and a wet mixing method are preferable in terms of uniformity, easy control of a reaction system, allowing the shape of a carbonaceous material to be maintained, or the like.

When low crystallinity carbon is used for preparing the carbonaceous material such that the integrated pore volume in pore diameters of 2 to 3.5 nm is 3.0×10⁻² cc/g or less, as a carbonaceous material precursor forming low crystallinity carbon, which is not particularly limited, aliphatic hydrocarbon, aromatic hydrocarbon, alicyclic hydrocarbon, or the like may be used in a chemical vapor deposition method. Specifically, it may be methane, ethane, propane, toluene, benzene, xylene, styrene, naphthalene, cresol, or anthracene, or a dielectric thereof.

In a wet mixing method and a mechanochemical method, a polymer compound such as a phenol resin or a styrene resin, or a solid material that can be carbonized such as pitch may be used directly as a solid or made into a dissolved substance for treatment.

Heat treatment in the treatment is preferably performed in an, inert atmosphere. Nitrogen and argon are suitable as an inert atmosphere. Treatment conditions are not particularly limited, but it is preferable when a dissolved substance is used that it be held at about 200° C. for a certain period of time, vaporizing a solvent, and then increased in temperature to a target temperature. For a temperature condition, 800° C. or more is preferable, 850° C. or more is more preferable, and 900° C. or more is furthermore preferable. Heat treatment at 800° C. or more allows carbonization of the carbonaceous material precursor to proceed sufficiently, facilitating provision of conductivity.

<Polymer>

As a polymer used in the embodiment of the present invention, a natural polymer, a synthetic polymer, or the like may be used. Among them, a water-soluble polymer is preferable in terms of environmental load and process cost. A water-soluble polymer can enter pores in the carbonaceous material, thereby reducing the integrated pore volume in particular pores of the carbonaceous material. At this time, when the integrated pore volume in pore diameters of 2 to 3.5 nm of the carbonaceous material is 3.0×10⁻² cc/g or less, the water-soluble polymer is not particularly limited, but may be, for example, polyvinyl pyrrolidone, polyvinyl alcohol, carboxymethyl cellulose salt, polyacrylic acid, polyacrylate, polyvinyl sulfonic acid, polyvinyl sulfonate, poly 4-vinylphenol, poly 4-vinylphenol salt, polystyrene sulfonic acid, polystyrene sulfonate, polyaniline sulfonic acid, algin acid, alginate, or the like. Among them, polyvinyl pyrrolidone, polyvinyl alcohol, carboxymethyl cellulose salt, polyacrylate, polyvinyl sulfonate, poly 4-vinylphenol salt, polystyrene sulfonic acid, and alginate are preferable. In terms of being able to selectively coat pores, it is desirable to use polyvinyl pyrrolidone as a polymer material other than salts. As a salt, an ammonium salt, a potassium salt, a lithium salt, or a sodium salt is preferable. As a polymer, one or more kinds of the above-described materials may be used.

The pH of an aqueous solution in which 50 mass % of the carbonaceous material is dispersed is a value measured at 25° C. in temperature and 50% in humidity, using a pH meter (for example, CyberScanpH110 manufactured by Eutech). When 50 mass % of the carbonaceous material is dispersed in purified water, the pH of the aqueous solution is preferably 6 or more, and more preferably 6.5 or more. With a pH of 6 or more, the interaction with an aqueous binder facilitates attainment of the irreversible capacity reducing effect.

The pH of an aqueous solution in which 1 mass % of a water-soluble polymer is dissolved is a value measured at 25° C. in temperature and 50% in humidity, using a pH meter (for example, CyberScanpH110 manufactured by Eutech). The pH of the aqueous solution in which 1 mass % of the water-soluble polymer is dissolved is preferably 5 or more. In a range of ph less than 5, the irreversible capacity reducing effect is reduced.

<Volume Average Particle Diameter>

The volume average particle diameter (D50) of the carbonaceous material in the embodiment of the present invention is not particularly limited, but is preferably 5 μm or more to 40 μm or less, and more preferably 7 to 30 μm. The carbonaceous material with a volume average particle diameter of 5 μm or more facilitates enhancement in electrode density, and that with 40 μm or less tends to improve electrode characteristics such as rate characteristics. The particle size distribution can be measured with a laser diffraction type particle size distribution measurement apparatus (LA-920 manufactured by HORIBA, Ltd.) by dispersing a sample in purified water containing a surfactant), and the average particle diameter is calculated as 50% D.

<Tap Density>

The tap density of the carbonaceous material in the embodiment of the present invention is not particularly limited. For example, it is preferably 0.6 to 1.2 g/cc, and more preferably 0.75 to 1.1 g/cc. Being 0.6 g/cc or more, it improves the cycle characteristics. Further, compressibility in pressing for forming a negative electrode is improved, a high electrode density is attained, and a battery with a higher capacity can be obtained. On the other hand, being 1.2 g/cc or less, it can prevent degradation in battery characteristics. This is probably because the particle diameter of the carbonaceous material and the density of the carbonaceous material itself, for example, have an effect on the giving and receiving and the diffusion of Li ions. The tap density of composite particles is measured pursuant to JIS R1628.

<Manufacturing Method of Negative Electrode Material>

A manufacturing method of a carbonaceous material is not particularly limited as long as the integrated pore volume thereof in pore diameters of 2 to 3.5 nm is 3.0×10⁻² cc/g or less. For example, the manufacturing method includes a step of obtaining a carbonaceous material and some other step as necessary.

When low crystallinity carbon is used for preparing the carbonaceous material such that the integrated pore volume thereof in pore diameters of 2 to 3.5 nm is 3.0×10⁻² cc/g or less, a wet mixing method and a chemical vapor deposition method are preferable in terms of uniformity. The wet mixing method includes a method in which pitch is dissolved in an aromatic hydrocarbon base solvent that can dissolve the pitch, and the solvent and the carbonaceous material are mixed and dispersed, and heat-treated, for example.

When a water-soluble polymer is used for preparing the carbonaceous material such that the integrated pore volume thereof in pore diameters of 2 to 3.5 nm is 3.0×10⁻² cc/g or less, it is preferable to make the water-soluble polymer into an aqueous solution in advance in terms of uniformity. A method of dissolving a water-soluble polymer is not particularly limited as long as the water-soluble polymer is dissolved in water. For example, it is possible to put 99 g of pure water into a plastic container and then put 1 g of a water-soluble polymer therein and dissolve the water-soluble polymer. During dissolution, heat or vibration may be added as appropriate. Heat is preferably of a temperature lower than or equal to the decomposition temperature of a polymer used.

In order to make the integrated pore volume in pore diameters of 2 to 3.5 nm, 3.0×10⁻² cc/g or less, using a water-soluble polymer, it is preferable to include, for example, a step of mixing a carbonaceous material with an aqueous solution in which 1 mass of a polymer is dissolved in advance, and a step of drying after mixing.

When a combination of a mixer (T. K. Robomix manufactured by PRIMIX Corporation) and a homo diaper is used, for example, a condition of mixing at a rotation speed of 500 to 5000 rpm for five to sixty minutes may be used; however, this is not particularly limited as long as mixing is possible. During mixing, purified water may be added as necessary because viscosity differs, depending on a polymer used. The amount of a polymer adhered to a carbonaceous material is not particularly limited, but is preferably 5 mass % or less. At 5 mass % or more, the percentage of the polymer not contributing to charging and discharging increases compared with an active material, so that it becomes difficult to make a high-capacity battery.

The drying step is not particularly limited as long as it can remove water, but drying at a temperature lower than or equal to the decomposition temperature of a polymer used is preferable.

For imparting a shearing force, there is no particular limitation on an apparatus therefor as long as it can impart a shearing force by which the volume average particle diameter of the carbonaceous material falls in a desired range. A common apparatus such as a mixer, a cutter mill, a hammer mill, or a jet mill may be used therefor. As a condition for imparting a shearing force by which the volume average particle diameter of the carbonaceous material falls in a desired range, which depends on an apparatus used, when a mixer (Waring mixer: 7012S manufactured by WARING) is used, for example, a condition of shearing at a rotation speed of 3000 to 13000 rpm for a period of 30 seconds to three minutes may be used. Processing of imparting a shearing force may be any generally used in the art such as pulverization processing or disintegration processing as long as it puts a lump material into individual pieces of a carbonaceous material forming the lump material while not destroying the carbonaceous material.

It is preferable to include a classifying step for particle size regulation after the step of imparting a shearing force. With this, a carbonaceous material having a uniform volume average particle diameter can be obtained. For classification, it is preferable to use a screen with openings of 40 μm, for example.

After the adhesion of low crystallinity carbon, a water-soluble polymer may be further adhered as long as it provides an integrated pore volume of 3.0×10⁻² cc/g or less in pore diameters of 2 to 3.5 nm of the carbonaceous material.

Further, this manufacturing method may further include a step of mixing some other component as necessary. Some other component may be a material having conductivity (conductive auxiliary material), a binder, or the like, for example.

<Negative Electrode for Lithium Ion Secondary Battery>

A negative electrode for lithium ion secondary battery in an embodiment of the present invention includes the previously-described negative electrode material in the present invention, and includes some other component as necessary. With this, a lithium ion secondary battery excellent in irreversible capacity reduction can be constructed.

The negative electrode for lithium ion secondary battery can be obtained by kneading the previously-described negative electrode material according to the embodiment of the present invention and an organic binding material with a solvent by a dispersing apparatus such as a mixer, a ball mill, a super sand mill, or a pressure kneader, preparing a negative electrode material slurry, and applying this to a current collector to form a negative electrode layer, or forming a negative electrode material slurry in a paste into a shape such as a sheet or a pellet, and integrating this with a current collector.

The above-described organic binding material (hereinafter, also referred to as “binder”) is not particularly limited, but may be, for example, a polymer compound such as styrene-butadiene copolymer; (meth)acrylic copolymer including ethylenically unsaturated carboxylic ester (for example, methyl (meth)acrylate, ethyl (meth)acrylate, butyl (meth)acrylate, (meth)acrylonitrile, hydroxyethyl (meta)acrylate, or the like), and ethylenically unsaturated carboxylic acid (for example, acrylic acid, methacrylic acid, itaconic acid, fumaric acid, maleic acid, or the like); polyvinylidene fluoride, polyethylene oxide, polyepichlorohydrin, polyphosphazene, polyacrylonitrile, polyimide, or polyamide imide. These organic binding materials include those dispersed or dissolved in water and those dissolved in an organic solvent such as N-methyl-2-pyrrolidone (NMP), depending on their respective properties.

The content ratio of the organic binding material in the negative electrode active material (carbonaceous material) of the negative electrode for lithium ion secondary battery is preferably 0.5 to 20 mass %, and more preferably 0.75 to 10 mass %. The content ratio of the organic binding material being 0.5 mass or more provides good adhesion, and prevents the negative electrode from being broken by expansion/contraction during charging and discharging. On the other hand, being 20 mass % or less, it can prevent the electrode resistance from becoming large.

A thickener for adjusting viscosity may be added to the negative electrode material slurry. As the thickener, for example, carboxymethyl cellulose, methyl cellulose, hydroxymethyl cellulose, ethyl cellulose, polyvinyl alcohol, polyacrylic acid, polyacrylate, oxidized starch, casein, alginic acid, alginate, or the like may be used.

A conductive auxiliary material may be mixed with the negative electrode material slurry as necessary. As the conductive auxiliary material, examples include carbon black, graphite, coke, carbon fiber, carbon nanotube, acetylene black, or an oxide or a nitride exhibiting conductivity, and the like. The amount of use of the conductive auxiliary material may be about 0.1 to 20 mass % with respect to a lithium ion secondary battery in the present invention.

The material and shape of the current collector are not particularly limited. For example, a strip of aluminum, copper, nickel, titanium, stainless steel, or the like formed in a foil, a perforated foil, mesh, or the like may be used. Alternatively, a porous material such as, for example, porous metal (foamed metal) or carbon paper may be used.

A method of applying the negative electrode material slurry to the current collector is not particularly limited. Examples include known methods such as a metal mask printing method, an electrostatic coating method, a dip coating method, a spray coating method, a roll coating method, a doctor blade method, a gravure coating method, and a screen printing method. After application, it is preferable to perform rolling by a flat-plate press, a calendar roll, or the like as necessary.

The integration between the negative electrode material slurry formed in a shape such as a sheet or a pellet and the current collector may be performed by a known method such as rolling, pressing, or a combination of them.

A negative electrode layer formed on a current collector and a negative electrode layer integrated with a current collector are preferably heat-treated, depending on an organic binding material used. For example, the negative electrode layers are preferably heat-treated at 100 to 180° C. when an organic binding material with polyacrylonitrile as a main skeleton is used, and at 150 to 450° C. when an organic binding material with polyimide or polyamide imide as a main skeleton is used.

This heat treatment advances removal of a solvent and enhancement of strength by hardening of a binder, allowing improvement in adhesion between particles and between particles and a current collector. These heat treatments are preferably performed in an inert atmosphere such as helium, algon, or nitrogen, or in a vacuum atmosphere to prevent oxidation of a current collector during treatment.

A negative electrode is preferably pressed (pressure-treated) before heat treatment. Pressure treatment allows adjustment of the electrode density. For the negative electrode for lithium ion secondary battery material in the present invention, the electrode density is preferably 1.3 to 1.9 g/cc, more preferably 1.4 to 1.7 g/cc, and furthermore preferably 1.45 to 1.65 g/cc. Being 1.3 g/cc or more, it improves adhesion and improves cycle characteristics. On the other hand, being 1.8 g/cc or less, it prevents destruction of the particle shape of the carbonaceous material.

<Negative Electrode Active Material>

An example described below illustrates control of the integrated pore volume by low crystallinity carbon and a water-soluble polymer, which is not particularly limited as long as the integrated pore volume in pore diameters of 2 to 3.5 nm of a carbonaceous material is 3.0×10⁻² cc/g or less.

As negative electrode active materials, spheroidal natural graphite (A) and spheroidal natural graphite (B) are illustrated.

Spheroidal natural graphite (A): spheroidal natural graphite with an integrated pore volume of 4.7×10⁻² cc/g in pore diameters of 2 to 3.5 nm, and a volume average particle diameter (D50) of 19.8 μm

Spheroidal natural graphite (B): spheroidal natural graphite with an integrated pore volume of 6.9×10⁻² cc/g in pore diameters of 2 to 3.5 nm, and a volume average particle diameter (D50) of 13.1 μm

<Lithium Ion Secondary Battery>

A lithium ion secondary battery in an embodiment of the present invention uses the negative electrode for lithium ion secondary battery in the embodiment of the present invention, and can be obtained by, for example, disposing the negative electrode for lithium ion secondary battery in the embodiment of the present invention opposite to a positive electrode with a separator therebetween, and injecting an electrolytic solution.

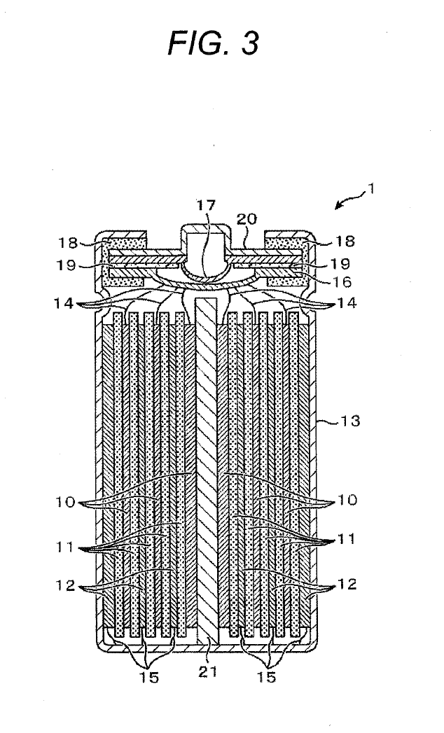

FIG. 3 is a diagram schematically illustrating an internal configuration of a battery according to the embodiment of the present invention. A battery 1 according to the embodiment of the present invention illustrated in FIG. 3 is composed of a positive electrode 10, separators 11, a negative electrode 12, a battery can 13, positive electrode current collector tabs 14, negative electrode current collector tabs 15, an inner lid 16, an internal pressure release valve 17, a gasket 18, a PTC element 19 as a positive temperature coefficient (PTC) resistive element, a battery lid 20, and an axis core 21. The battery lid 20 is an integrated component including the lid 16, the internal pressure release valve 17, the gasket 18, and the PTC element 19. The positive electrode 10, the separators 11, and the negative electrode 12 are wound around the axis core 21.

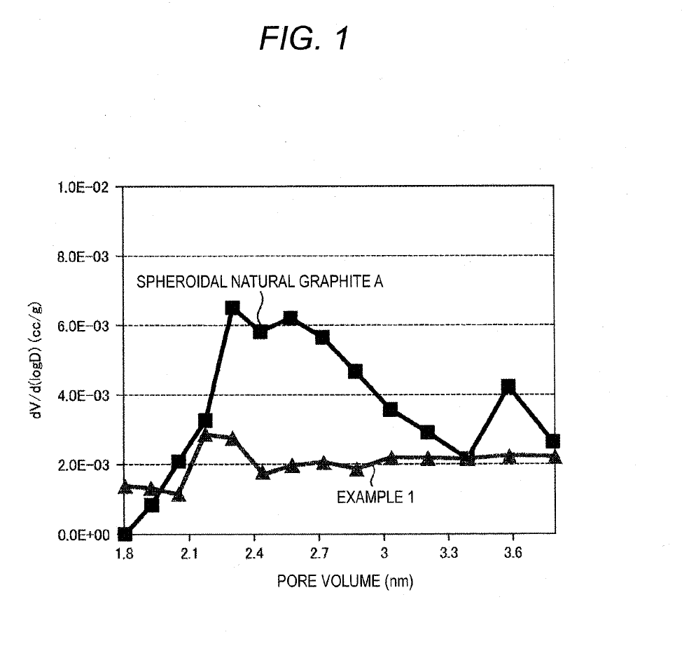

An electrode group with the separators 11 inserted between the positive electrode 10 and the negative electrode 12, wound around the axis core 21 is prepared. For the axis core 21; any of known ones can be used as long as it can support the positive electrode 10, the separators 11, and the negative electrode 12. The electrode group may be made in various shapes other than a cylindrical shape illustrated in FIG. 1, such as one in which strip-shaped electrodes are laminated, or one in which the positive electrode 10 and the negative electrode 12 are wound in a desired shape such as in a flat shape. For the shape of the battery can 13, a shape such as a cylindrical shape, a flat oblong shape, a flat elliptical shape, or a square shape may be selected, according to the shape of the electrode group.

The material of the battery can 13 is selected from materials having corrosion resistance to a non-aqueous electrolyte, such as those made of aluminum, stainless steel, and nickel plated steel. When the battery can 13 is electrically connected to the positive electrode 10 or the negative electrode 12, the material of the battery can 13 is selected such that the material in a portion contacting a non-aqueous electrolyte is not changed in quality due to corrosion of the battery can 13 or alloying with lithium ions.

The electrode group is housed in the battery can 13, the negative electrode current collector tabs 15 are connected to the inner wall of the battery can 13, and the positive electrode current collector tabs 14 are connected to the bottom surface of the battery lid 20. The electrolytic solution is injected into the battery can 13 before hermetically sealing the battery. Methods of injecting an electrolytic solution include a method of directly adding the electrolytic solution to the electrode group with the battery lid 20 opened, and a method of adding the electrolytic solution through an inlet provided in the battery lid 20.

Thereafter, the battery lid 20 is brought into close contact with the battery can 13 to hermetically seal the entire battery. When there is an inlet of an electrolytic solution, it is also hermetically sealed. Methods of hermetically sealing a battery include known techniques such as Welding and caulking.

<Positive Electrode>

A positive electrode is configured by a positive electrode active material, a conductive agent, a binder, and a current collector. Examples of the positive electrode active material include LiCoO₂, LiNiO₂, and LiMn₂O₄, which are typical examples. In addition, LiMnO₃, LiMn₂O₃, LiMnO₂, Li₄Mn₅O₁₂, LiMn₂₋ₓMxO₂ (wherein, at least one kind selected from a group including M=Co, Ni, Fe, C, Zn, and Ti, x=0.01 to 0.2) Li₂Mn₃MO₈ (wherein, at least one kind selected from a group including M=Fe, Co, Ni, Cu, and Zn), Li₁₋ₓAₓMn₂O₄ (wherein, at least one kind selected from a group including A=Mg, B, Al, Fe, Co, Ni, Cr, Zn, and Ca, x=0.01 to 0.1), LiNi₁₋ₓMₓO₂ (wherein, at least one kind selected from a group including M=Co, Fe, and Ga, x=0.01 to 0.2), LiFeO₂, Fe₂(SO₄)₃, LiCo₁₋ₓMₓO₂ (wherein, at least one kind selected from a group including M=Ni, Fe, and Mn, x=0.01 to 0.2), LiNi₁₋ₓMₓO₂ (wherein, at least one kind selected from a group including M=Mn, Fe, Co, Al, Ga, Ca, and Mg, x=0.01 to 0.2), Fe(MoO₄)₃, FeF₃, LiFePO₄, LiMnPO₄, and so on can be enumerated.

The particle diameter of the positive electrode active material is usually specified so as to be lower than or equal to the thickness of a mixture layer formed from the positive electrode active material, the conductive agent, and the binder. When there are coarse particles having a size larger than or equal to the mixture layer thickness in powder of the positive electrode active material, it is preferable to remove the coarse particles in advance by screen classification, wind-flow classification, or the like to prepare particles smaller than or equal to the mixture layer thickness.

Since the positive electrode active material is an oxide system and thus generally has a high electrical resistance, a conductive agent including carbon powder for compensating for the electrical conductivity is used. Since the positive electrode active material and the conductive agent are both usually powders, mixing a binder with the powders can combine the powders together and at the same time adhere the combined powders to the current collector.

For the current collector of the positive electrode, an aluminum foil with a thickness of 10 to 100 μm, a perforated aluminum foil with a thickness of 10 to 100 μm and a pore diameter of 0.1 to 10 mm, an expanded metal, a foamed metal plate, or the like is used. A material other than aluminum, such as stainless or titanium may also be used. In the present invention, any current collector can be used without being limited by a material, shape, manufacturing method, or the like.

After the positive electrode slurry in which the positive electrode active material, the conductive agent, the binder, and the organic solvent are mixed is adhered to the current collector by the doctor blade method, dipping method, spraying method, or the like, the organic solvent is dried, and pressure-forming by roll pressing is performed, whereby the positive electrode can be prepared. Alternatively; by performing a process from coating to drying multiple times, a plurality of mixture layers can be laminated on a current collector.

<Separator>

A separator is inserted between the positive electrode and the negative electrode prepared by the above methods to prevent short circuit of the positive electrode and the negative electrode. For the separator, a polyolefin polymer sheet made from polyethylene, polypropylene, or the like, a two-layered structure in which a polyolefin polymer and a fluorine polymer sheet exemplified by tetrafluoropolyethylene are welded, or the like can be used. To prevent the separator from contracting when the battery temperature increases, a mixture of ceramic and a binder may be formed in a thin layer on the surface of the separator. These separators can be generally used in the lithium ion battery as long as the pore diameter is 0.01 to 10 μm, and the porosity is 20 to 90% because the separators need to pass lithium ions through them during charging and discharging of the battery.

<Electrolyte>

Typical examples of an electrolytic solution that can be used in the embodiment of the present invention include a solution in which lithium hexafluorophosphate (LiPF₆) or lithium borofluoride (LiBF₄) is dissolved as an electrolyte in a solvent in which dimethyl carbonate, diethyl carbonate, ethyl methyl carbonate, or the like is mixed with ethylene carbonate. In the present invention, other electrolytic solutions can be used without being limited by the type of a solvent or an electrolyte, and the mixing ratio of a solvent.

Examples of non-aqueous solvents that can be used for the electrolytic solution include non-aqueous solvents such as propylene carbonate, ethylene carbonate, butylene carbonate, vinylene carbonate, γ-butyrolactone, dimethyl carbonate, diethyl carbonate, methyl ethyl carbonate, 1,2-dimethoxyethane, 2-methyltetrahydropyran, dimethyl sulfoxide, 1,3-dioxolane, formamide, dimethyl formamide, methyl propionate, ethyl propanoate, phosphate triester, trimethoxymethane, dioxolan, diethyl ether, sulfolane, 3-methyl-2-oxazolidinone, tetrahydrofuran, 1,2-diethoxyethane, chloroethylene carbonate, or chloropropylene carbonate. Other solvents may be used as long as they do not decompose on the positive electrode 10 or the negative electrode 12 incorporated in the battery of the present invention.

Examples of the electrolyte include various kinds of lithium salts such as LiPF₆, LiBF₄, LiClO₄, LiCF₃SO₃, LiCF₃CO₂, LiAsF₆, and LiSbF₆, and imide salts of lithium exemplified by lithium trifluoromethanesulfonimide. A non-aqueous electrolytic solution made by dissolving one of these salts in the above-described solvent can be used as an electrolytic solution for the battery. Other electrolytes may be used as long as they do not decompose on the positive electrode 10 and the negative electrode 12 that the battery according to this embodiment has.

When a solid polymer electrolyte (polymer electrolyte) is used, an ion conducting polymer such as polyethylene oxide, polyacrylonitrile, polyvinylidene fluoride, polymethylmethacrylate, polyhexafluoropropylene, or polyethylene oxide may be used for an electrolyte. Use of these solid polymer electrolytes provides an advantage that the separators 11 can be omitted.

Further, an ionic liquid may be used. For example, a combination that do not decompose on the positive electrode and the negative electrode can be selected from 1-ethyl-3-methylimidazolium tetrafluoroborate (EMI-BF4), a mixed complex of lithium salt LiN(SO₂CF₃)₂(LiTFSI), triglyme, and tetraglyme, alicyclic quaternary ammonium positive ions (exemplified by Nmethyl-N-propylpyrrolidinium), and imide negative ions (exemplified by bis(fluorosulfonyl)imide, to be used in the battery according to this embodiment.

The structure of the lithium ion secondary battery in the embodiment of the present invention is not particularly limited, but generally is a structure in which a positive electrode, a negative electrode, and separators provided as necessary are wound in a flat scroll shape to be a wounded polar plate group or formed in flat plates and laminated to be a laminated polar plate group, and the polar plate group is encapsulated in a sheathing body.

The lithium ion secondary battery in the embodiment of the present invention is used as a paper-type battery, button-type battery, a coin-type battery, a multilayer-type battery, the above-described cylindrical battery, a square battery, or the like, but not particularly limited thereto.

The above-described negative electrode material in the embodiment of the present invention can be used in electrochemical devices in general in which insertion and desorption of lithium ions constitute a charge-discharge mechanism, such as, a hybrid capacitor, in addition to a lithium ion secondary battery.

### EXAMPLES

Hereinafter, the present invention will be described in detail with examples, but the present invention is not limited to these examples. Unless otherwise specified, “part” and “%” are based on mass.

### Example 1

First, 150 g of spheroidal natural graphite (A) with a volume average particle diameter of 19.8 μm and an integrated pore volume of 4.7×10⁻² cc/g in pore diameters of 2 to 3.5 nm was mixed with 75 g of an aqueous solution in which 1% polyvinyl alcohol is dissolved. The mixture was mixed at a rotation speed of 2000 rmp for 30 minutes by a mixer (T. K. Robomix manufactured by PRIMIX Corporation) combined with a homo disper to prepare a slurry. The slurry was put into a stainless vat, dried by an 80° C. stationary operation dryer, and then vacuum-dried by a 105° C. vacuum drier for four hours to remove water.

The obtained lump material was disintegrated under a condition of rotation speed 3100 rmp for one minute, using a waring mixer (7012S manufactured by WARING), and then classified with a vibration screen having 40 μm openings to provide composite particles of 20 μm in volume average particle diameter that constitute a carbonaceous material (negative electrode material). The reason why the volume average particle diameter of the obtained carbonaceous material is different from the volume average particle diameter of the spheroidal natural graphite (A) is probably that the surface of the spheroidal natural graphite (A) is partly or entirely coated with polyvinyl alcohol, so that fine particles partly agglomerate, having an effect on the average particle diameter more or less.

The carbonaceous material obtained by the above-described manufacturing method was evaluated in average interplanar spacing, integrated pore volume, and volume average particle diameter by methods described below. Evaluation results are shown in Table 1. FIG. 1 illustrates a pore distribution map of the carbonaceous material in this example.

[Average Interplanar Spacing (d₀₀₂) (XRD Measurement)]

It was performed with an X-ray wide-angle diffraction measurement device manufactured by Rigaku Corporation to calculate average interplanar spacing (d₀₀₂) based on a JSPS method.

[Integrated Pore Volume (Pore Diameters of 2 to 3.5 nm) (Nitrogen Gas Adsorption Measurement)]

It was calculated, using nitrogen adsorption measurement device AUTOSORB-1 manufactured by Quantachrome Instruments from the adsorption side of the nitrogen adsorption measurement calculable by the BJH method.

[Average Particle Diameter (50% D) Measurement]

The volume average particle diameter (50% D) was measured, using a laser diffraction grain size distribution measurement device (LA-920 manufactured by HORIBA, LTD.), by putting a dispersion liquid with the carbonaceous material dispersed together with a surfactant in purified water into a sample water tank, and circulating it by a pump while subjecting it to ultrasound. The cumulative 50% particle diameter (50% D) of the obtained particle size distribution was taken as the volume average particle diameter.

[Manufacturing of Negative Electrode for Lithium Ion Secondary Battery]

A slurry in the proportions of 1.5 parts of SBR (BM-400B manufactured by Zeon Corporation) as a biding material, 1.5 parts of CMC (CMC2200 manufactured by Daicel Corporation), and 105 parts of purified water as a viscosity adjusting agent with respect to 97 parts of carbonaceous material was prepared. This slurry was applied to an electrolytic copper foil, using an applicator so that the solid content coating amount was 8 mg/and dried for two hours by an 80° C. stationary operation dryer. After drying, the resultant was further dried for two hours by a 105° C. vacuum dryer; and adjusted to an electrode density of 1.5 g/cc by a roll press machine to obtain the negative electrode for lithium ion secondary battery. The obtained lithium ion battery negative electrode was punched into a circle of 15 mmφ, and this was used as an electrode for evaluation.

[Preparation of Cell for Evaluation]

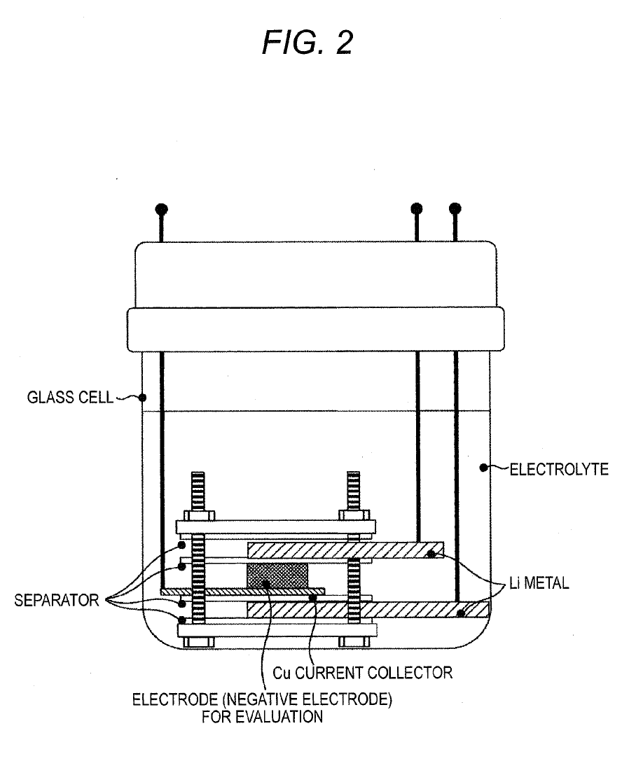

FIG. 2 shows a schematic diagram of a cell used for evaluation. As illustrated in FIG. 2, a cell for evaluation was prepared by putting a solution in which LiPF₆ as an electrolytic solution is dissolved in a mixed solvent of ethylene carbonate (EC) and ethyl methyl carbonate (EMC) (the volume ratio between EC and EMC is 1:2) in a concentration of 1 mol/L into a glass cell, and laminating a separator, a reference electrode. (metallic lithium), a separator, a copper foil, an electrode for evaluation, a separator, an opposite electrode (metallic lithium), and a separator in this order.

[Evaluation Condition]

The cell for evaluation was put into a constant temperature bath at 25° C. to perform a charging and discharging test. Charging was performed until a current value reached 0.2 mA at a constant voltage of 0V after charging to 0V with a constant current of 2 mA. Discharging was performed up to a voltage value of 1.5 V with a constant current of 2 mA. Table 1 shows the initial discharge capacity and the irreversible capacity per unit weight of the carbonaceous material in a first cycle.

### Example 2

A negative electrode material was prepared in a manner similar to that in Example 1 except that polyvinyl alcohol in Example 1 was replaced with polyvinylpyrrolidone, and similar evaluation was performed.

### Example 3

A negative electrode material was prepared in a manner similar to that in Example 1 except that polyvinyl alcohol in Example 1 was replaced with sodium polyacrylate, and similar evaluation was performed.

### Example 4

A negative electrode material was prepared in a manner similar to that in Example 1 except that polyvinyl alcohol in Example 1 was replaced with sodium carboxymethylcellulose, and similar evaluation was performed.

### Example 5

A negative electrode material was prepared in a manner similar to that in Example 1 except that polyvinyl alcohol in Example 1 was replaced with polyvinyl sodium sultanate, and similar evaluation was performed.

### Example 6

A negative electrode material was prepared in a manner similar to that in Example 1 except that polyvinyl alcohol in Example 1 was replaced with poly 4-sodium vinylphenol, and similar evaluation was performed.

### Example 7

A negative electrode material was prepared in a manner similar to that in Example 1 except that polyvinyl alcohol in Example 1 was replaced with sodium polystyrenesulfonate, and similar evaluation was performed.

### Example 8

A negative electrode for lithium ion secondary battery material was prepared in a manner similar to that in Example 1 except that polyvinyl alcohol in Example 1 was replaced with polyaniline sulfonate, and similar evaluation was performed.

### Example 9

A negative electrode material was prepared in a manner similar to that in Example 1 except that polyvinyl alcohol in Example 1 was replaced with carboxymethyl ammonium, and similar evaluation was performed.

### Example 10

A negative electrode material was prepared in a manner similar to that in Example 1 except that polyvinyl alcohol in Example 1 was replaced with sodium alginate, and similar evaluation was performed.

### Example 11

A negative electrode material was prepared in a manner similar to that in Example 1 except that polyvinyl alcohol in Example 1 was replaced with ammonium alginate, and similar evaluation was performed.

### Example 12

One hundred and fifty grams of spheroidal natural graphite (Q) with a volume average particle diameter of 19.8 μm and an integrated pore volume of 4.7×10⁻² cc/g in pore diameters of 2 to 3.5 nm was mixed with 20 grams of solution in which 40% of pitch (a residual carbon ratio of 50%) was dissolved in toluene. A slurry resulting from the mixing was held in a baking furnace in a nitride atmosphere at 200° C. for two hours to vaporize the solvent, and then baked at 900° C. for two hours to obtain a lump material. Other than this, a negative electrode material was prepared in a manner similar to that in Example 1, and similar evaluation was performed.

### Example 13

One hundred and fifty grams of carbonaceous material prepared in Example 12 was mixed with 50 grams of aqueous solution in which 1% of sodium polystyrenesulfonate was dissolved. The mixture was mixed by a mixer (T. K. Robomix manufactured by PRIMIX Corporation) combined with a homo disper at a rotation speed of 2000 rpm for 30 minutes to prepare a slurry. The slurry was put into a stainless vat, predried at 80° C., and then vacuum-dried at 100° C. for four hours to remove water. Other than this, a negative electrode material was prepared in a manner similar to that in Example 1, and similar evaluation was performed.

### Example 14

A negative electrode material was prepared in a manner similar to that in Example 1 except that the spheroidal graphite in Example 1 was replaced with B, and sodium polystyrenesulfonate was used, and similar evaluation was performed.

### Comparative Example 1

A negative electrode material was prepared in a manner similar to that in Example 1, using spheroidal natural graphite (A) directly without coating it with a polymer such as polyvinyl alcohol, and similar evaluation was performed.

### Comparative Example 2

A negative electrode material was prepared in a manner similar to that in Example 1, using spheroidal natural graphite (B) directly without coating it with a polymer such as polyvinyl alcohol, and similar evaluation was performed.

### Comparative Example 3

A negative electrode material was prepared in a manner similar to that in Example 1 except that the mixed quantity of polyvinyl alcohol in Example 1 was changed to 15 g, and similar evaluation was performed.

### Comparative Example 4

A negative electrode material was prepared by coating it with polyvinyl alcohol in a manner similar to that in Example 1 except that the spheroidal natural graphite in Example 1 was replaced with (B), and similar evaluation was performed.

### Comparative Example 5

A negative electrode material was prepared in a manner similar to that in Example 12 except that the amount of pitch mixed in Example 12 is changed to 10 g, and similar evaluation was performed.

TABLE 1

| | | | | | | | | Volume | | |
|---|---|---|---|---|---|---|---|---|---|---|
| | Negative | | Polymer | Pitch | Average | | | Average | Initial | Initial |
| | Electrode | | Mixed | Mixed | Interplane | Integrated Pore | | Particle | Discharge | Irreversible |
| | Active | | Quantity | Quantity | Spacing | Volume | | Diameter | Capacity | Capacity |
| | Material | Polymer | (g) | (g) | (nm) | (cc/g) | | (μm) | (mAh/g) | (mAh/g) |
| Example 1 | A | Polyvinyl alcohol | 75 | — | 0.336 | 1.5 × 10⁻² | 0.015 | 19.5 | 365 | 24 |
| Example 2 | A | Polyvinyl pyrrolidone | 75 | — | 0.336 | 8.3 × 10⁻³ | 0.0083 | 19.8 | 364 | 22 |
| Example 3 | A | Sodium polyacrylate | 75 | — | 0.336 | 5.8 × 10⁻³ | 0.0058 | 19.8 | 364 | 20 |
| Example 4 | A | Sodium | 75 | — | 0.336 | 7.3 × 10⁻³ | 0.0073 | 19.7 | 365 | 23 |
| | | carboxymethylcellulose | | | | | | | | |
| Example 5 | A | Sodium polyvinyl | 75 | — | 0.336 | 7.2 × 10⁻³ | 0.0072 | 19.9 | 365 | 21 |
| | | sulfonate | | | | | | | | |
| Example 6 | A | Sodium poly 4- | 75 | — | 0.336 | 1.3 × 10⁻² | 0.013 | 19.8 | 365 | 19 |
| | | vinylphenol | | | | | | | | |
| Example 7 | A | Sodium polystyrene | 75 | — | 0.336 | 5.3 × 10⁻³ | 0.0053 | 19.6 | 365 | 20 |
| | | sulfonate | | | | | | | | |
| Example 8 | A | Polyaniline sulfonate | 75 | — | 0.336 | 1.6 × 10⁻² | 0.016 | 19.6 | 363 | 26 |
| Example 9 | A | Ammonium carboxymethyl | 75 | — | 0.336 | 7.5 × 10⁻³ | 0.0075 | 19.7 | 364 | 21 |
| Example 10 | A | Sodium alginate | 75 | — | 0.336 | 8.5 × 10⁻³ | 0.0085 | 19.9 | 365 | 19 |
| Example 11 | A | Ammonium alginate | 75 | — | 0.336 | 8.9 × 10⁻³ | 0.0089 | 20 | 365 | 20 |
| Example 12 | A | — | — | 20 | 0.336 | 2.5 × 10⁻² | 0.025 | 20.2 | 364 | 26 |
| Example 13 | A | Sodium polystyrene | 75 | 20 | 0.336 | 6.7 × 10⁻³ | 0.0067 | 20.3 | 363 | 21 |
| | | sulfonate | | | | | | | | |
| Example 14 | B | Sodium polystyrene | 75 | — | 0.336 | 1.5 × 10⁻² | 0.015 | 13.4 | 365 | 23 |
| | | sulfonate | | | | | | | | |
| Comparative | A | — | — | — | 0.337 | 4.7 × 10⁻² | 0.047 | 19.8 | 366 | 35 |
| Example 1 | | | | | | | | | | |
| Comparative | B | — | — | — | 0.336 | 5.9 × 10⁻² | 0.059 | 13.1 | 363 | 45 |
| Example 2 | | | | | | | | | | |
| Comparative | A | Polyvinyl alcohol | 15 | — | 0.337 | 3.8 × 10⁻² | 0.038 | 19.5 | 364 | 33 |
| Example 3 | | | | | | | | | | |
| Comparative | B | Polyvinyl alcohol | 75 | — | 0.336 | 3.2 × 10⁻² | 0.032 | 13.2 | 363 | 36 |
| Example 4 | | | | | | | | | | |
| Comparative | A | — | — | 10 | 0.337 | 3.3 × 10⁻² | 0.033 | 20.1 | 364 | 33 |
| Example 5 | | | | | | | | | | |

Table 1 shows that the negative electrode for lithium ion secondary battery materials in Examples 1 to 14 reduce the irreversible capacity. It shows that the negative electrode for lithium ion secondary battery materials in Examples 2 to 7, 9 to 11, 13, and 14 reduce the irreversible capacity more because salts such as ammonium salts or sodium salts are used.

### REFERENCE SIGNS LIST

10 positive electrode:
11 separator
12 negative electrode
13 battery can
14 positive electrode current collector tab
15 negative electrode current collector tab
16 inner lid
17 internal pressure release valve
18 gasket
19 PTC element
20 battery lid
21 axis core

1. A negative electrode material containing a carbonaceous material, wherein:
the interplanar spacing (d₀₀₂) between (002) planes of the carbonaceous material determined by an X-ray wide-angle diffraction method is smaller than or equal to 0.338 nm;
the integrated pore volume of the carbonaceous material in pore diameters of 2 nm or more to 3.5 nm or less determined from a gas adsorption method is 5.0×10⁻³ cc/g or more to 3.0×10⁻² cc/g or less; and
a water-soluble polymer is contained in the carbonaceous material.

2. (canceled)

3. The negative electrode material according to claim 1, wherein the integrated pore volume of the carbonaceous material in pore diameters of 2 nm or more to 3.5 nm or less determined from the gas adsorption method is 1.5×10⁻² cc/g or less.

4. The negative electrode material according to claim 3, wherein the water-soluble polymer is one or more kinds of an ammonium salt, a potassium salt, and a sodium salt.

5. The negative electrode material according to claim 4, wherein the volume average particle diameter (D50) of the carbonaceous material is 5 μm or more to 40 μm or less.

6. The negative electrode material according to any of claim 5, wherein a carbonaceous material different from the carbonaceous material, a metallic material, or a polymer is contained in the carbonaceous material.

7. A negative electrode for lithium ion secondary battery having the negative electrode material according to claim 6.

8. A lithium ion secondary battery comprising the negative electrode for lithium ion secondary battery according to claim 7.

9. A manufacturing method of a negative electrode material containing a carbonaceous material, wherein:
the interplanar spacing (d₀₀₂) between (002) planes of the carbonaceous material determined by an X-ray wide-angle diffraction method is smaller than or equal to 0.338 nm;
the integrated pore volume of the carbonaceous material in pore diameters of 2 nm or more to 3.5 nm or less determined from a gas adsorption method is 5.0×10⁻³ cc/g or more to 3.0×10⁻² cc/g or less;
the pH of an aqueous solution when 50 mass % of the carbonaceous material is dispersed in purified water is 6 or more;
a water-soluble polymer is contained in the carbonaceous material; and
the pH of an aqueous solution prepared with 1 mass % of the water-soluble polymer in the aqueous solution is 5 or more.

10. (canceled)
